(19) United States
(12) Patent Application Publication
(10) Pub. No.: US 2006/0286274 A1
(43) Pub. Date: Dec. 21, 2006

(54) Method of preserving a fish meat product

(75) Inventor: Chun-Hsiung Tsai, Kaohsiung (TW)

Correspondence Address: PEARL COHEN ZEDEK, LLP;PEARL COHEN ZEDEK LATZER, LLP, 1500 BROADWAY 12TH FLOOR, NEW YORK, NY, 10036, US

(73) Assignee: Fortune Frozen Foods Co., Ltd.I

(21) Appl. No.: 11/156,456

(22) Filed: Jun. 21, 2005

(51) Int. Cl. A23L 1/325

(52) U.S. Cl. 426/643

(57) ABSTRACT

A method of preserving a fish meat product includes cleaning the fish meat product; packing the fish meat product with a vacuumed package which contains an oxygen-containing protective gas having a vacuum pressure ranging from 80% to 95% of atmosphere; and freezing the package together with the fish meat product.

### BACKGROUND OF THE INVENTION

1. Field of the Invention

The invention relates to a method of preserving a fish meat product, more particularly to a method of preserving a fish meat product in a vacuum package containing an oxygen-containing protective gas having a predetermined vacuum pressure.

2. Description of the Related Art

Fish meat is susceptible to bacterial spoilage. Therefore, fresh fish must be subjected to proper preservation treatments after harvesting in order to preserve freshness.

The most extensively adopted preservation treatments include bleeding, sterilizing, and low-temperature storing (e.g., cold storing or freezing) to help maintain the freshness and luster of fish meat. Thereafter, the fish is packaged and transported in cold storage so as to preserve the freshness of the fish meat for an extended period.

Fish packaging techniques generally include vacuum packaging and modified or controlled atmosphere packaging. In comparison, vacuum packed fish meat is prone to color changes and an escape of tissue exudates from the fish meat.

Moreover, vacuum packed fish meat may be contaminated by anaerobes, such as Clostridium botulinum. If the vacuum packed fish meat is inadvertently exposed to a temperature exceeding 4° C., anaerobic Clostridium botulinum will breed to decompose the fish meat, thereby resulting in bad odor, decoloration and putrification of the fish meat. Furthermore, Clostridium botulinum may build up in the fish meat before color change of the fish meat is observable, thereby posing a serious threat to consumers.

In addition, as the vacuum package needs to be opened for thawing the fish meat, once the fish meat comes into contact with the air after the vacuum package is opened for thawing, bacteria may breed to contaminate the fish meat.

In view of the aforesaid problems associated with vacuum packed fish meat, controlled or modified atmosphere packaging of fish products is becoming more and more popular, and invites research and development.

### SUMMARY OF THE INVENTION

Therefore, the object of the present invention is to provide a method of preserving a fish meat product, which can inhibit growth of both aerobic and anaerobic bacteria to thereby preserve the freshness of the fish meat product.

According to this invention, a method of preserving a fish meat product includes:
(a) cleaning the fish meat product;
(b) packing the fish meat product in a vacuumed package which contains an oxygen-containing protective gas having a vacuum pressure ranging from 80% to 95% of atmosphere; and
(c) freezing the package together with the fish meat product.

### BRIEF DESCRIPTION OF THE DRAWINGS

Other features and advantages of the present invention will become apparent in the following detailed description of the preferred embodiment with reference to the accompanying drawing, of which:

FIG. 1 is a flowchart illustrating the preferred embodiment of a method of preserving a fish meat product according to this invention.

### DETAILED DESCRIPTION OF THE PREFERRED EMBODIMENT

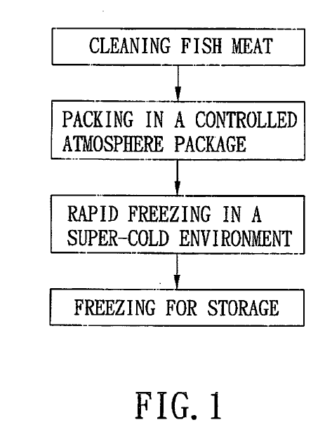

Referring to FIG. 1, the preferred embodiment of a method of preserving a fish meat product according to the present invention is mainly used for fish that can be cut into relatively thin slices after skinning, such as Taiwan porgy, cobia, greater amberjack, salmon, tuna, etc. The method of this invention includes the step of cleaning the fish meat product in a low-temperature environment. The cleaning step includes bleeding, gutting, and sterilizing the fish meat product to help preserve the freshness of the fish meat product and to maintain the fish meat product in a sterilized condition.

Next, the sterilized fish meat product is packed in a sterilized package which is vacuumed and which is subsequently filled with an oxygen-containing protective gas having a vacuum pressure ranging from 80% to 95% of atmosphere before sealing. Thus, the fish meat product can be preserved in a controlled atmosphere containing a predetermined amount of oxygen so as to effectively prevent breeding of both aerobic and anaerobic bacteria/microorganisms, thereby preserving the freshness of the fish meat product. In this embodiment, the vacuum pressure of the oxygen-containing protective gas ranges from 720 mmHg to 700 mmHg. The oxygen-containing protective gas is air, and includes oxygen, carbon dioxide, and nitrogen.

Thereafter, the package together with the fish meat product is frozen quickly in a super-cold environment having a temperature ranging from −60° C. to −70° C. so as to further inhibit growth of bacteria.

Afterwards, the package together with the fish meat product is stored in a freezing environment having a temperature ranging from −20° C. to −60° C. after being frozen at the temperature of −60° C. to −70° C.

In this invention, since the fish meat product is stored in a package containing air having a vacuum pressure ranging from 80% to 95% of atmosphere, growth of both aerobic and anaerobic bacteria inside the package can be inhibited to preserve the freshness of the fish meat product. Furthermore, as the package contains a suitable amount of air therein, the fish meat product can be thawed in the refrigerator or at room temperature with the package intact to prevent contamination of the fish meat product by bacteria. Thus, the drawbacks associated with the prior art can be effectively eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of preserving a fish meat product, comprising:
(a) cleaning the fish meat product;
(b) packing the fish meat product in a vacuumed package which contains an oxygen-containing protective gas having a vacuum pressure ranging from 80% to 95% of atmosphere; and
(c) freezing the package together with the fish meat product.

2. The method as claimed in claim 1, wherein the vacuum pressure of the oxygen-containing protective gas ranges from 720 mmHg to 700 mmHg.

3. The method as claimed in claim 2, wherein, in step (c), the vacuumed package is frozen quickly in a super-cold environment having a temperature ranging from −60° C. to −70° C.

4. The method as claimed in claim 3, wherein the vacuumed package is further stored in a freezing environment having a temperature ranging from −20° C. to −60° C. after being frozen at the temperature of −60° C. to −70° C.

5. The method as claimed in claim 1, wherein, in step (b), the oxygen-containing protective gas is air.

6. The method as claimed in claim 1, wherein, in step (b), the oxygen-containing protective gas includes oxygen, carbon dioxide, and nitrogen.

7. The method as claimed in claim 1, wherein the fish meat product is sterilized in step (a).
